(19) United States
(12) Patent Application Publication
(10) Pub. No.: US 2025/0377463 A1
(43) Pub. Date: Dec. 11, 2025

(54) SENSOR UNIT FOR A LIDAR MEASUREMENT

(71) Applicant: Robert Bosch GmbH, Stuttgart (DE)

(72) Inventors: Mario Lietz, Vaihingen An Der Enz (DE); Benjamin Schmidt, Stuttgart (DE); Holger Maris Gilbergs, Sersheim (DE)

(21) Appl. No.: 19/190,260

(22) Filed: Apr. 25, 2025

(30) Foreign Application Priority Data
Apr. 29, 2024 (DE) 10 2024 203 996.9

(51) Int. Cl. G01S 17/931; G01S 17/58

(52) U.S. Cl. CPC G01S 17/931; G01S 17/58

(57) ABSTRACT

A sensor unit for a lidar measurement. The sensor unit including: an emitter element configured to emit at least one signal having a first orientation, a receiver element configured to record at least one reflection of the emitted signal having a second orientation, wherein the sensor unit is configured to detect and/or receive a distance between the sensor unit and an object element, wherein the sensor unit is configured to adjust the first orientation and/or the second orientation as a function of the distance.

### FIELD

The present invention relates to a sensor unit for a lidar measurement, to a method for operating a sensor unit, to a computer program and to a vehicle.

### BACKGROUND INFORMATION

There are currently a variety of different solutions for operating a lidar sensor unit in the vehicle sector. Due to the increasing number of measuring tasks as well as the increased quality characteristics, the need for innovative and robust lidar measuring systems is continuously increasing.

Continuous weight reduction in the vehicle sector for reducing consumption and increasing competition are putting pressure on costs, and therefore cheaper and more efficient components for vehicles are in greater demand.

### SUMMARY

Compared to what is currently available, the sensor unit according to the present invention for a lidar measurement may have the advantage that parallax can be avoided in bi-axial lidar systems by adjusting the orientation or alignment of the transmitted and received element accordingly. In particular, the viewing direction of the light source and of the receiver can be adjusted to each other, in particular as a function of the expected detection distance of the object to be measured. Further preferably, the alignment or spatial direction can be ascertained individually for each pixel, so that no reduction in sensitivity occurs due to parallax and thus a substantially perfect alignment between the light source and the receiver can exist both in the far range and in the close range. In particular, a loss of sensitivity in the close range of the sensor unit can be reduced without the image quality in the close range being affected or impaired by optical scattering elements.

According to an example embodiment of the present invention, this is achieved in that the sensor unit for a lidar measurement comprises an emitter element and a receiver element. The emitter element is configured to emit at least one signal having a first orientation, wherein the receiver element is configured to record at least a first reflection of the emitted signal having a second orientation, wherein the sensor unit is configured to detect and/or receive a distance between the sensor unit and an object element, wherein the sensor unit is configured to adjust the first orientation and/or the second orientation as a function of the distance.

In other words, the sensor unit can determine both the first orientation of the signal which is sent by the emitter element, and can ascertain or calculate the second orientation with which the reflection of the emitted signal is detected by means of the receiver element. In this way, an offset, such as that caused by parallax or the like, can be corrected. Further preferably, the sensor unit can detect and/or receive a distance between an object to be detected, such as an obstacle, and the sensor unit, so that the first orientation and/or the second orientation can be adjusted as a function of the detected or received distance. In particular, the distance can also detect a three-axis offset between the sensor unit and the object.

Preferred developments of the present invention are disclosed herein.

According to an example embodiment of the present invention, the sensor unit is preferably configured to create a link between the first orientation and the second orientation, wherein the sensor unit is configured to adjust the link as a function of the distance. An advantage of this embodiment is that a correlation between the two orientations of the further processing can be taken into account when aligning or adjusting the first orientation and the second orientation.

Further preferably, according to an example embodiment of the present invention, the receiver element comprises a receiving surface having at least a first pixel and a second pixel, wherein the sensor unit is configured to detect the first reflection by means of the first pixel and to detect a second reflection having a third orientation by means of the second pixel, wherein the sensor unit is configured to adjust the first orientation, the second orientation and/or the third orientation between detecting the first reflection and detecting the second reflection.

An advantage of this example embodiment of the present invention is that by adjusting the first and the second, or the third orientation between a first measurement with the first signal and a second measurement with the second signal, the relevant orientation can be adjusted accordingly in order to thus further increase the signal energy.

According to an example embodiment of the present invention, the sensor unit is further preferably configured to adjust the receiving surface in order to set the second orientation.

An advantage of this example embodiment is that by adjusting the receiving surface, the second orientation can be set in order to thus be able to react to the changed environmental parameter.

According to an example embodiment of the present invention, the sensor unit is further preferably configured to select a subset of pixels from a plurality of pixels in order to adjust the receiving surface.

An advantage of this example embodiment is that the energy consumption of the sensor unit can be reduced, because the pixels used for reception can already be selected, so that all other pixels can be deactivated.

According to an example embodiment of the present invention, the sensor unit is preferably configured to select the subset of pixels as a function of the distance.

An advantage of this example embodiment is that, as a function of a close range to be detected or a far range to be detected, the relevant pixels can be selected which have the highest probability of successful detection.

According to an example embodiment of the present invention, the sensor unit is further preferably configured to adjust an alignment of the receiving surface and/or a size of the receiving surface in order to set the second orientation.

An advantage of this example embodiment is that the second orientation can be specifically set by using an active control element, such as an actuator and/or a lens.

According to an example embodiment of the present invention, the sensor unit is further preferably configured to adjust an alignment of the emitter element in order to set the first orientation.

An advantage of this example embodiment is that, in the case of a fixedly aligned receiving surface or a receiving element, the first orientation can also be adjusted in order to thus be able to monitor a close range in particular.

Further preferably, according to an example embodiment of the present invention, the emitter element comprises a plurality of signal sources, wherein the sensor unit is configured to select a set of signal sources from the plurality of signal sources in order to adjust the first orientation.

An advantage of this example embodiment is that, in particular in the case of a laser system comprising an optical component, only a part of the sources is selected in order to thus be able to adjust the first orientation. The sensor unit is preferably configured to receive an assistance signal, wherein the sensor unit is configured to adjust the first orientation and/or the second orientation as a function of the assistance signal.

An advantage of this example embodiment is that the sensor unit can react to a request from a driver assistance system, such as a lane keeping assist system or the like, by adjusting the first and/or the second orientation. Preferably, the assistance signal is an indicator or the like, which is transmitted from an assistance system, such as the lane keeping assistant, to the sensor unit.

According to an example embodiment of the present invention, the sensor unit is further preferably configured to identify a horizon, wherein the sensor unit is configured to adjust the first orientation and/or the second orientation as a function of the identified horizon.

An advantage of this example embodiment is that in particular a close range can be determined by using the horizon in order to thus be able to compensate in particular for a loss of sensitivity in the close range, i.e., below the horizon.

According to an example embodiment of the present invention, the sensor unit is preferably configured to emit the signal at a first point in time and a further signal at a second point in time by means of the emitter element, wherein the receiver element is configured to detect the signal at a third point in time and the further signal at a fourth point in time, wherein the sensor unit is configured to adjust the first orientation between the first point in time and the second point in time, wherein the sensor unit is configured to adjust the second orientation between the third point in time and the fourth point in time.

An advantage of this example embodiment is that a sequence of different measurements by means of the sensor unit each has an individually adjusted first and second orientation in order to further increase the detection accuracy.

According to an example embodiment of the present invention, the sensor unit is further preferably configured to receive and/or detect a speed signal which is indicative of a travel speed of the sensor unit, wherein the sensor unit is configured to adjust the first orientation and/or the second orientation as a function of the speed signal.

An advantage of this example embodiment is that the operating mode can be adjusted depending on the relevant situation. For example, when driving slowly in the city or in a traffic jam, every second frame or even a complete configuration for the close range can be selected.

A further aspect of the present invention relates to a method for operating a sensor unit. According to an example embodiment of the present invention, the method further comprises the steps of:
detecting and/or ascertaining a distance between the sensor unit and an object element,
adjusting, as a function of the distance, a first orientation of a signal emitted by an emitter element and/or a second orientation of a reflection of the emitted signal received by a receiver element.

A further aspect of the present invention relates to a computer program which is configured to carry out steps of the method according to the present invention, as described above and below.

A further aspect of the present invention relates to a vehicle that comprises a sensor unit according to the present invention as described above and below and/or comprises a control device configured to carry out steps of the method according to the present invention as described above and below.

### BRIEF DESCRIPTION OF THE DRAWINGS

In the following, exemplary embodiments of the present invention are described in detail with reference to the figures.

FIG. 1 shows a sensor unit according to one example embodiment of the present invention.

FIG. 2A and 2B show a sensor unit according to one example embodiment of the present invention.

FIG. 3 shows a flow chart illustrating steps of the method according to one example embodiment of the present invention.

FIG. 4 shows a vehicle according to one example embodiment of the present invention.

### DETAILED DESCRIPTION OF EXAMPLE EMBODIMENTS

Preferably, all the same units, elements and/or steps in all figures are provided with the same reference signs.

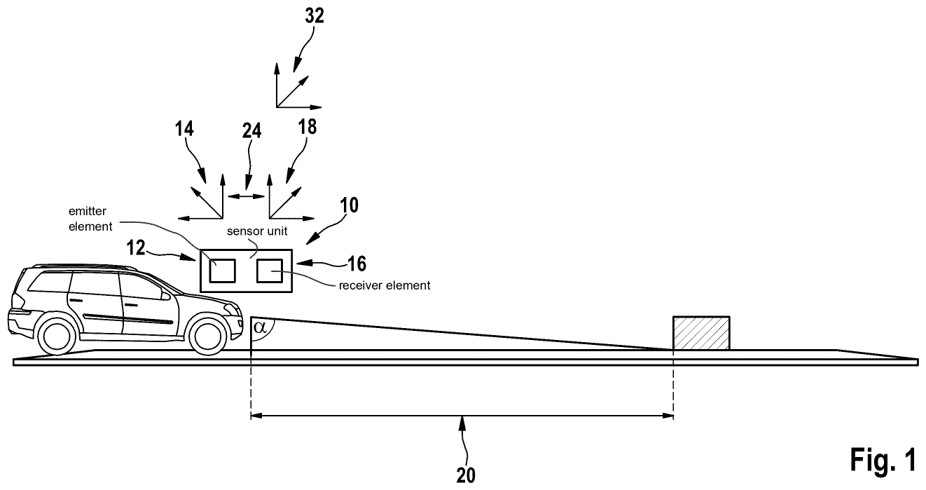

FIG. 1 shows a sensor unit 10 according to one embodiment. The sensor unit 10 for a lidar measurement comprises an emitter element 12 which is configured to emit at least one signal having a first orientation 14, and comprises a receiver element 16 which is configured to record at least a first reflection of the emitted signal having a second orientation 18, wherein the sensor unit 10 is configured to detect and/or receive a distance 20 between the sensor unit 10 and an object element 22, wherein the sensor unit 10 is configured to adjust the first orientation 14 and/or the second orientation 18 as a function of the distance 20.

The sensor unit 10 is further preferably configured to detect a second reflection having a third orientation 32 by means of the second pixel 30, wherein the sensor unit 10 is configured to adjust the first orientation 14, the second orientation 18 and/or the third orientation 32 between detecting the first reflection and detecting the second reflection.

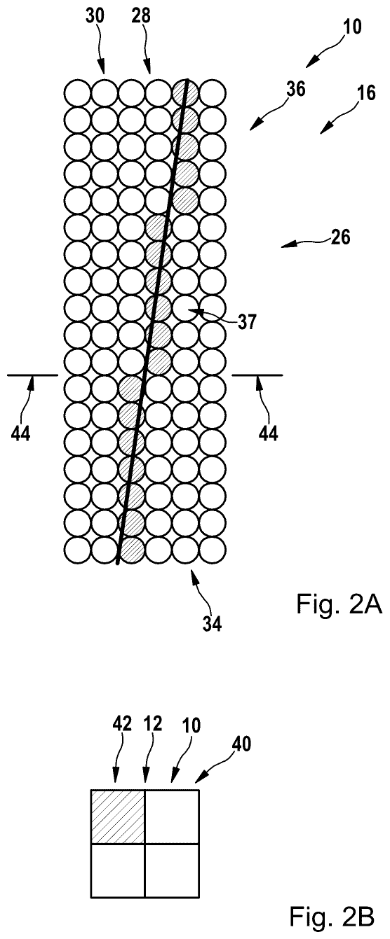

FIG. 2A shows a sensor unit 10 according to one embodiment. The sensor unit 10 comprises a receiver element 16. The receiver element 16 preferably comprises a receiving surface 26 having a first pixel 28 and a second pixel 30. The sensor unit 10 is further preferably configured to select a subset of pixels 34 from a plurality of pixels 36 by means of adjusting the receiving surface 26. As shown in FIG. 2A, a signal curve 37 is projected onto the subset 34 of pixels, wherein the signal curve 37 is in particular a reflection of an emitted signal. FIG. 2B shows a sensor unit 10 according to one embodiment. The sensor unit 10 comprises an emitter element 12. Further preferably, the emitter element 12 has a plurality of signal sources 40, wherein the sensor unit 10 is configured to select a set of signal sources 42 from the plurality of signal sources 40 in order to adjust the first orientation 14.

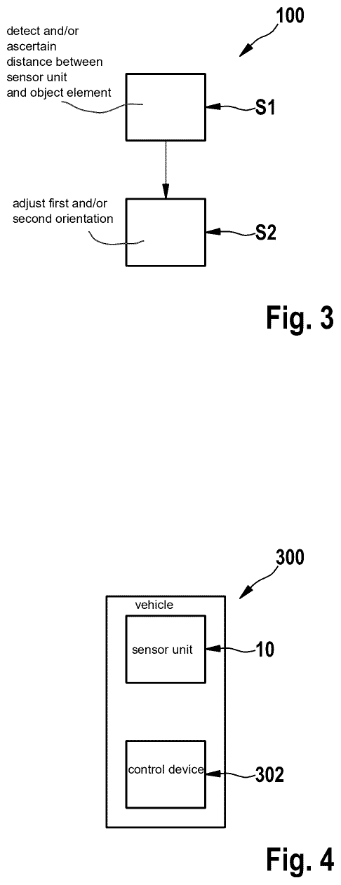

FIG. 3 shows a flow chart illustrating steps of the method 100 according to one embodiment. The method 100 for operating a sensor unit 10 preferably comprises the following steps:
detecting and/or ascertaining S1 a distance 20 between the sensor unit 10 and an object element (22),
adjusting S2, as a function of the distance 20, a first orientation 14 of a signal emitted by an emitter element 12 and/or a second orientation 18 of a reflection of the emitted signal received by a receiver element 16.

FIG. 4 shows a vehicle 300 according to one embodiment. The vehicle 300 comprises a sensor unit 10 as described above and below and/or a control device 302 configured to carry out steps of the method 100 as described above and below.

1-15. (canceled)

16. A sensor unit for a lidar measurement, comprising:
an emitter element configured to emit at least one signal having a first orientation; and
a receiver element configured to record at least one first reflection of the emitted signal having a second orientation;
wherein the sensor unit is configured to detect and/or receive a distance between the sensor unit and an object element; and
wherein the sensor unit is configured to adjust the first orientation and/or the second orientation as a function of the distance.

17. The sensor unit according to claim 16, wherein the sensor unit is configured to create a link between the first orientation and the second orientation, and wherein the sensor unit is configured to adjust the link as a function of the distance.

18. The sensor unit according to claim 16, wherein the receiver element includes a receiving surface having at least a first pixel and a second pixel, wherein the sensor unit is configured to detect a first reflection using the first pixel and to detect a second reflection having a third orientation using the second pixel, wherein the sensor unit is configured to adjust the first orientation and/or the second orientation and/or the third orientation between detecting the first reflection and detecting the second reflection.

19. The sensor unit according to claim 18, wherein the sensor unit is configured to adjust the receiving surface to set the second orientation.

20. The sensor unit according to claim 19, wherein the sensor unit is configured to select a subset of pixels from a plurality of pixels in order to adjust the receiving surface.

21. The sensor unit according to claim 20, wherein the sensor unit is configured to select subsets of pixels as a function of the distance.

22. The sensor unit according to claim 18, wherein the sensor unit is configured to adjust an alignment of the receiving surface and/or a size of the receiving surface in order to set the second orientation.

23. The sensor unit according to claim 16, wherein the sensor unit is configured to adjust an alignment of the emitter element to set the first orientation.

24. The sensor unit according to claim 16, wherein the emitter element has a plurality of signal sources, wherein the sensor unit is configured to select a set of signal sources from the plurality of signal sources to adjust the first orientation.

25. The sensor unit according to claim 16, wherein the sensor unit is configured to receive an assistance signal, wherein the sensor unit is configured to adjust, as a function of the assistance signal, the first orientation and/or the second orientation.

26. The sensor unit according to claim 16, wherein the sensor unit is configured to identify a horizon, wherein the sensor unit is configured to adjust, as a function of the identified horizon, the first orientation and/or the second orientation.

27. The sensor unit according to claim 16, wherein the sensor unit is configured to receive and/or detect a speed signal which is indicative of a travel speed of the sensor unit, wherein the sensor unit is configured to adjust, as a function of the speed signal, the first orientation and/or the second orientation.

28. The sensor unit according to claim 16, wherein the sensor unit is configured to emit, using the emitter element, the signal at a first point in time and a further signal at a second point in time, wherein the receiver element is configured to detect the signal at a third point in time and the further signal at a fourth point in time, wherein the sensor unit is configured to adjust the first orientation between the first point in time and the second point in time, wherein the sensor unit is configured to adjust the second orientation between the third point in time and the fourth point in time.

29. A method for operating a sensor unit, comprising the following steps:
detecting and/or ascertaining a distance between the sensor unit and an object element; and
adjusting, as a function of the distance, a first orientation of a signal emitted by an emitter element of the sensor unit and/or a second orientation of a reflection of the emitted signal received by a receiver element of the sensor unit.

30. A vehicle comprising:
sensor unit for a lidar measurement, including:
an emitter element configured to emit at least one signal having a first orientation, and
a receiver element configured to record at least one first reflection of the emitted signal having a second orientation,
wherein the sensor unit is configured to detect and/or receive a distance between the sensor unit and an object element, and
wherein the sensor unit is configured to adjust the first orientation and/or the second orientation as a function of the distance
